(19) United States
(12) Patent Application Publication
(10) Pub. No.: US 2005/0095902 A1
(43) Pub. Date: May 5, 2005

(54) Connector assembly

(76) Inventors: Hongbo Zhang, Kunsan (CN); Yi Sheng Lin, Tu-Chen (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/979,909

(22) Filed: Nov. 1, 2004

(30) Foreign Application Priority Data
Nov. 4, 2003 (TW) 92219536

(51) Int. Cl. H01R 12/24

(52) U.S. Cl. 439/493

(57) ABSTRACT

An electrical connector assembly (100) includes a printed circuit board (1), a plug (2) and an out shell (3). The plug includes an insulative housing (21) and a plurality of conductive terminals (22) held in the housing. The out shell is mounted on the printed circuit board. A receiving room (34) for receiving the plug is defined by the out shell and the printed circuit board.

### BACKGROUND OF THE INVENTION

1. Field of the Invention

This invention generally relates to an electrical connector assembly for printed circuit boards and more particularly, to those which are flexible.

2. Description of the Prior Art

U.S. Pat. No. 5,813,877 issued on Sep. 29, 1998 discloses an electrical connector, the conventional connector assembly is soldered to a printed circuit board for electrically connecting cables and the printed circuit board. The conventional connector assembly includes a receptacle and a plug for mating with the receptacle. The receptacle comprises an insulative housing and a plurality of conductive terminals held in the housing. The housing defines a plurality of grooves for receiving the terminals. Each conductive terminal includes a soldering portion for soldering to the printed circuit board, a contacting portion for contacting with the plug and a fixing portion for fixing the insulative housing on the printed circuit board. Cables are soldered to the plug. When the plug mates with the receptacle, the cables of the plug connect with the conductive terminals of the receptacle, thereby electrically connecting with the printed circuit board. However, the insulative housing and the conductive terminals adopted in the receptacle inevitably increases the height of the receptacle decreasing, thereby inconsistent with the development tide of short, small, light and thin of electrical connector.

In addition, to transmit high frequency signals, the receptacle needs an out shell for shielding electromagnetism interference. However, adding the out shell further complicates the manufacture of the receptacle and increases the cost of the electrical connector.

### BRIEF SUMMARY OF THE INVENTION

It is an object of the present invention to provide an electrical connector assembly which has a simple structure and can be easily manufactured.

In order to attain the object above, an electrical connector assembly includes a printed circuit board, a plug and an out shell. The plug includes an insulative housing and a plurality of conductive terminals held in the housing. The out shell is mounted on the printed circuit board. A receiving room for receiving the plug is defined by the out shell and the printed circuit board. The present invention uses an out shell soldered to the printed circuit board as a receptacle, thereby effectively decreasing the height of the electrical connector assembly and further simplifying the structure and manufacture of the electrical connector assembly and adapting the development tide of short, small, light and thin of electrical connector.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a perspective view of an electrical connector assembly according to the present invention;

FIG. 2 is a partially perspective view of the electrical connector assembly; and

FIG. 3 is a perspective view of the electrical connector assembly.

### DETAILED DESCRIPTION OF THE INVENTION

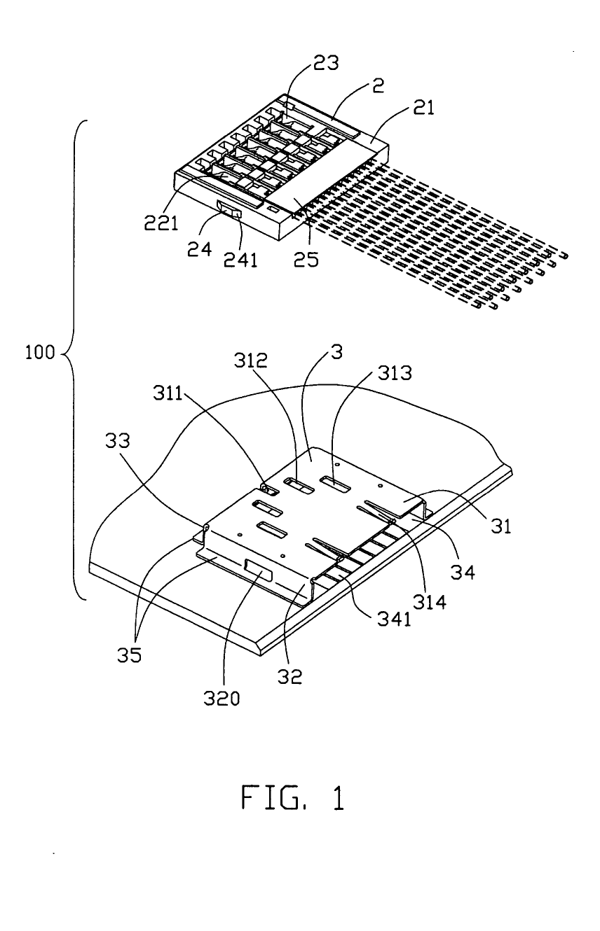

Referring to FIG. 1, an electrical connector assembly 100 in accordance with the present invention adapted for electrically connecting cables (not labeled) includes a printed circuit board 1, a plug 2 and an out shell 3. A plurality of cables shown in dashed lines electrically connect with the plug 2.

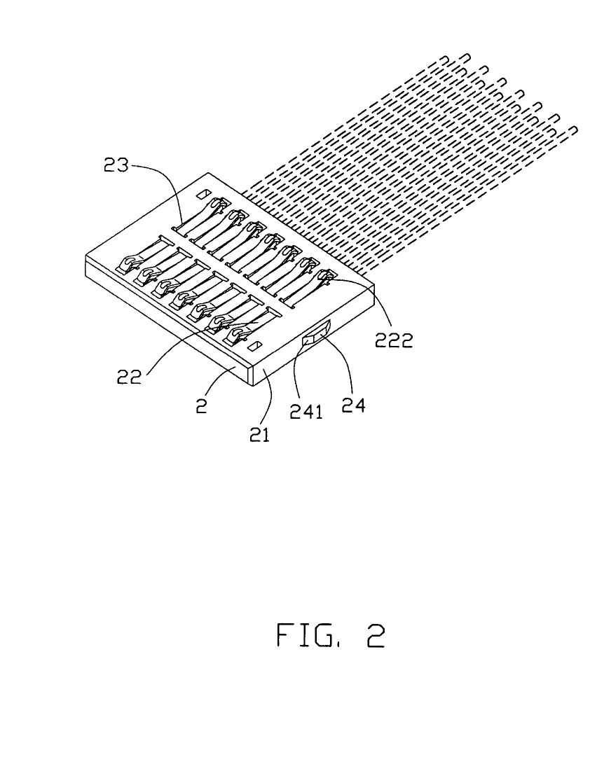

Referring to FIG. 2, the plug 2 includes an insulative housing 21 and a plurality of conductive terminals 22 held in the housing 21. The housing 21 is of substantially plat cassette and defines a plurality of grooves 23 for receiving the conductive terminals 22. A grounding plate 25 is positioned in a rear portion of a top wall of the insulative housing 21. A pair of ribs 24 outwardly project from opposite sides of the housing 21. A pair of incline planes 241 are formed at two sides of each rib 241.

Referring to FIGS. 1-2, each conductive terminal 22 includes a body portion 221 and a contacting portion 222 downwardly extending and bending from an end portion of the body portion 221. The other end portion of the body portion 221 connects with a corresponding cable. The contacting portions 222 project beyond the housing 21 for contacting with circuit traces 341 of the printed circuit board 1.

Referring to FIG. 1, the out shell 3 is formed of sheet metal for decreasing effectively electromagnetism interference. The out shell 3 is mounted on the printed circuit board 1, thereby forming a receiving room 34 for receiving the plug 2. The out shell 3 is provided with a top wall 31 substantially parallel to the printed circuit board 1, a pair of side walls 32 extending downwardly from two sides of the top wall 31 and a rear wall 33 extending and bending downwardly from a rear portion of the top wall 31. The top wall 31 defines a first slot 311, a pair of second slots 312 and a pair of third slots 313. The first slot 311 is positioned in the rear portion of the top wall 31 and through a top portion of the rear wall 33. The pair of second slots 312 are adjacent to a front section of the first slot 311 and are parallel to the first slot 311. The second slots 312 lie in opposite sides of the front slot 311. The pair of consistent third slots 313 lie in front of corresponding second slot 312 and are parallel to the second slots 312. The third slots 313 lie in an outside of the corresponding second slots 312. The top wall 31 forms a pair of spring fingers 314 downwardly extending and bending from a front portion thereof for engaging with the grounding plate 25 of the insulative housing 21 of the plug 2. A plurality of soldering portions 35 outwardly extend and bend from bottom portions of the rear wall 33 and the side walls 32 for soldering to the printed circuit board 1. The soldering portion 35 is soldered to the printed circuit board 1 so that the out shell 3 is mounted on the printed circuit board 1. The out shell 3 defines a pair of openings 320 at a substantially middle portion of the side walls 32 for engaging with the ribs 24 of the plug 2.

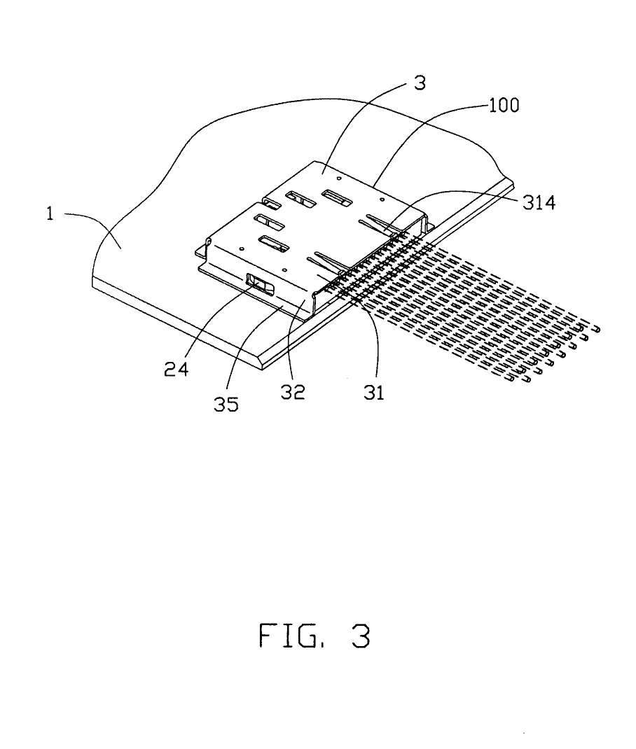

Referring to FIGS. 1-3, firstly, the conductive terminals 22 are assembled in the grooves 23 of the insulative housing 21 of the plug 2. The contacting portions 222 of the conductive terminals 22 downwardly project beyond the housing 21 for facilitating contacting with the circuit traces 341 of the printed circuit board 1. Secondly, the cables are soldered to the body portion 221 of the conductive terminals 22, thereby establishing electrical connections between the cables 4 and the conductive terminals 22. The soldering portions 35 of the out shell 3 are soldered to the printed circuit board 1 so that the out shell 3 is mounted on the printed circuit bard 1, thereby forming the receiving room 34.

In use, the insulative housing 21 of the plug 2 is inserted into the receiving room 34 of the out shell 3, at the same time, the ribs 24 of the insulative housing 1 engage with the openings 320 of the side walls 32 of the out shell 3. The spring fingers 314 of the top wall 31 of the out shell 3 downwardly press the grounding plate of the insulative housing 21 of the plug 2. The contacting portions 222 of the conductive terminals 22 electrically connect with the circuit traces 341 of the printed circuit board 1, whereby an electrical connecting between the cables and the printed circuit bard 1 is formed.

When the plug 2 disengages from the receptacle, the plug 2 is forwardly pushed by a screwdriver through the first slot 311, the second slots 312 and the third slots 313 in turn. The inclined planes 241 of the ribs 24 are pushed forwardly to glide along the out shell 3. As a result, the ribs 24 depart from the openings 320 and the plug 2 disengage from the receiving room 34 of the out shell 3.

The electrical connector assembly 100 according to the present invention uses the out shell 3 mounted on the printed circuit board 1 to define the receiving room 34 therebetween for retaining the plug 2 on the printed circuit board 1, thereby directly connecting the conductive terminals 22 of the plug 2 and the printed circuit board 1, decreasing a whole height of the electrical connector assembly 100 and adapting to development tide of short, small, light and thin of electrical connectors.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. An electrical connector assembly comprising:
a printed circuit board comprising a plurality of circuit traces;
an outer shell mounted on the printed circuit board and, together with the printed circuit board defining a receiving room; and
a plug mating with the outer shell, the plug comprising an insulative housing and a plurality of conductive terminals held in the housing electrically connecting the circuit traces of the printed circuit board.

2. The electrical connector assembly according to claim 1, wherein the plurality of circuit traces are positioned in the receiving room for contacting with the conductive terminals of the plug.

3. The electrical connector assembly according to claim 1, wherein the outer shell defines a pair of openings communicating with the receiving room, and wherein the insulative housing of the plug comprises a pair of ribs for engaging with the openings.

4. The electrical connector assembly according to claim 3, wherein each rib comprises an inclined plane for facilitating disengaging the rib from the opening.

5. The electrical connector assembly according to claim 1, wherein the outer shell comprises a spring finger projecting into the receiving room for pressing the plug.

6. The electrical connector assembly according to claim 1, wherein the outer shell defines a slot communicating with the receiving room for facilitating push the plug out from the receiving room by a screwdriver.

7. The electrical connector assembly according to claim 1, wherein the out shell defines a first slot positioned in a rear portion thereof, a pair of second slots positioned in front of the first slot and a pair of third slots positioned in front of the second slot.

8. The electrical connector assembly according to claim 7, wherein the second slots lie in opposite outsides of the first slot and the third slots lie outside of the second slots.

9. An electrical assembly comprising:
a printed circuit board having a plurality of circuit traces on an upper surface;
a metallic shell attached to the upper surface and cooperating with said printed circuit board to define a receiving cavity;
a cable connector including a housing with contacts and associated wires thereof; wherein
the housing is inserted into the receiving cavity in an insertion direction parallel to said upper surface, and the contacts mechanically and electrically engaged with the corresponding circuit traces.

10. The electrical assembly as claimed in claim 9, wherein said housing is insulative.

11. The electrical assembly as claimed in claim 10, further including interengaging devices on the metallic shell and the housing to fix the shell and the housing together.

12. The electrical assembly as claimed in claim 11, wherein said metallic shell defines an opening to allow an initial insertion of a tool to push the housing to initially leave the receiving cavity in a withdrawal direction opposite to said insertion direction.

13. The electrical assembly as claimed in claim 12, wherein said metallic shell further includes another opening offset from said opening in said withdrawal direction to allow a successive insertion of the tool to successively push the housing to further leave the receiving cavity in said withdrawal direction.
